(19) United States
(12) Patent Application Publication
(10) Pub. No.: US 2015/0020974 A1
(43) Pub. Date: Jan. 22, 2015

(54) BAFFLE AND APPARATUS FOR TREATING SURFACE OF BAFFLE, AND SUBSTRATE TREATING APPARATUS

(71) Applicant: PSK INC., Gyeonggi-do (KR)

(72) Inventor: YoungYeon JI, Hwaseong-si (KR)

(21) Appl. No.: 13/946,162

(22) Filed: Jul. 19, 2013

(51) Int. Cl. H05H 15/00

(52) U.S. Cl. CPC H05H 15/00
USPC 156/345.33; 156/345.3

(57) ABSTRACT

The present invention relates to a substrate treating apparatus, and more particularly, to an apparatus treating a substrate using plasma. In an embodiment, a baffle is formed with holes distributing a process gas excited to a plasma state, and has a surface which is treated with a surface treating material comprising a silicon compound.

### BACKGROUND OF THE INVENTION

The present invention disclosure herein relates to a substrate treating apparatus, and more particularly, to an apparatus treating a substrate using plasma.

A plasma is an ionized gas state comprised of ions, electrons, radicals, and the like, and is generated by an extremely high temperature, a strong electric field, or an RF electromagnetic field.

Such a plasma is variously utilized in a lithography process using photoresist so as to manufacture semiconductor devices. In an example, the use of a plasma has been increased in a patterning process in which various fine circuit patterns such as line or space patters are formed on a substrate, or in an ashing process in which a photoresist film used as a mask in an ion implantation process is removed.

Korean Patent No. 10-1165725 discloses a substrate treating apparatus performing an ashing process. A plasma source gas is discharged to a plasma state by an induced magnetic field acting on the particles inside a reactor, and the discharged gas is supplied to the substrate to remove a photoresist film.

While the plasma gas is supplied to the substrate, active species and radicals contained in the plasma gas react with a surface of an apparatus having a polarity and thus are dissipated. Since the decrease in the number of the active species and radical reduces their reaction opportunity with the photoresist film, the ashing rate is reduced.

### PRIOR ART DOCUMENTS

### Patent Documents

Korean Patent No. 10-1165725

### SUMMARY OF THE INVENTION

The present invention provides a baffle.

Embodiments of the present invention provide baffles formed with holes designed for distributing a process gas excited to a plasma state, wherein surfaces of the baffles may be treated with a surface treating material including a silicon compound.

In some embodiments, the baffle may have a base formed with the holes, and a ring-shaped coupling part protruding upward from an upper edge surface of the base, and the surface treating material may be applied to a bottom surface of the base.

In other embodiments, the inner side surface of the process chamber which is surface-treated may have a non-polar state.

In still other embodiments, the silicon compound may include hexamethyldisiloxane (HMDSO).

In even other embodiments, the surface-treated baffle may be coated with silicon dioxide (SiO₂).

In other embodiments of the present invention, surface treating apparatuses include a process chamber formed therein with a space, a susceptor positioned inside the process chamber to support a substrate, and a process gas supply unit supplying a process gas in a plasma state to an inside of the process chamber, wherein an inner side surface of the process chamber is surface-treated with a surface treating material including a silicon compound.

In some embodiments, the inner side surface of the process chamber which is surface-treated may have a non-polar state.

In other embodiments, the surface-treated baffle may be coated with silicon dioxide (SiO₂).

In even other embodiments, the above surface treating apparatus may further include a baffle which is positioned above the susceptor and in which holes designed for distributing the process gas supplied to the substrate are formed, wherein the baffle is surface-treated with the surface treating material.

In still other embodiments, the baffle may have a bottom surface which faces the substrate and is surface-treated.

In yet other embodiments, the bottom surface of the baffle which is surface-treated may have a non-polar state.

In further embodiments, the bottom surface of the baffle which is surface-treated may be coated with silicon dioxide (SiO₂).

In still other embodiments of the present invention, baffle surface treating apparatuses include a surface treating chamber formed therein with a space, a support plate which is positioned inside the surface treating chamber and provided as a lower electrode, and on which a baffle is placed, an upper electrode which is disposed above the support plate to face the support plate and forms an electric field between the support plate and the upper electrode, and a surface treating gas supply unit supplying a surface treating gas including a silicon compound to a space between the support plate and the upper electrode, wherein the surface treating gas is excited to a plasma state by the electric field and treats a surface of the baffle.

In some embodiments, the baffle may have a base formed with holes, and a ring-shaped coupling part protruding upward from an upper edge region of the base, wherein the baffle may be placed on the support plate such that the bottom surface of the base faces the upper electrode.

In other embodiments, the surface treating gas supply unit may include a container containing a surface treating material including the silicon compound, an inert gas supply part which injects an inert gas to the container to pressurize an inside of the container, and a gas supply line connecting the surface treating chamber and the container and supplying the surface treating gas generated in the inside of the container to the inside of the surface treating chamber.

In even other embodiments, the surface treating gas supply unit may include a container containing a surface treating material including the silicon compound, a heater heating an inside of the container, and a gas supply line connecting the surface treating chamber and the container and supplying the surface treating gas generated in the inside of the container to the inside of the surface treating chamber.

In still other embodiments, the silicon compound may include hexamethyldisiloxane (HMDSO).

According to an embodiment of the present invention, since the active species and radical are prevented from decreasing, the ashing rate is enhanced.

The effects of the present invention are not limited to those described above, and other effects that are not mentioned will be clearly understood to a person skilled in the art from the present specification and the accompanying drawings.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a plan view simply illustrating a substrate treating equipment according to an embodiment of the present invention;

FIG. 2 is a sectional view schematically illustrating a substrate treating apparatus according to an embodiment of the present invention;

FIG. 3 is a sectional view illustrating a substrate treating apparatus according to an embodiment of the present invention;

FIG. 4 is a sectional view illustrating a substrate treating apparatus according to another embodiment of the present invention;

FIG. 5 is a sectional view illustrating a substrate treating apparatus according to still another embodiment of the present invention; and

FIG. 6 is a graph showing the ashing rates of process chambers having different surface states.

### DETAILED DESCRIPTION OF PREFERRED EMBODIMENTS

Hereinafter, exemplary embodiments will be described in detail with reference to the accompanying drawings. The embodiments of the present invention may be modified in various forms, and the scope of the present invention should not be construed as limited to the following embodiments. These embodiments are provided so that this disclosure will more fully convey the concept of the invention to those skilled in the art. Therefore, the shapes of elements are exaggerated for more clear description.

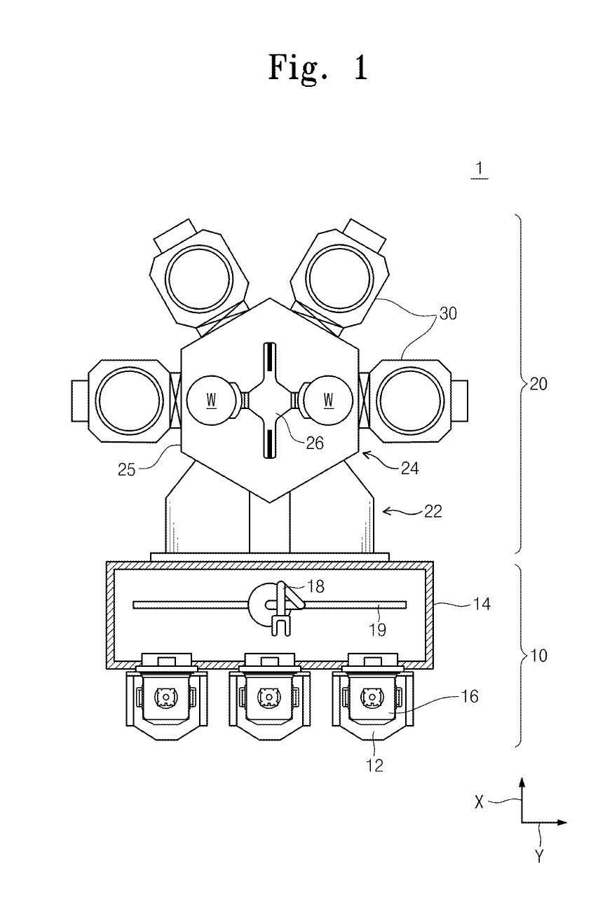

FIG. 1 is a plan view simply illustrating a substrate treating apparatus according to an embodiment of the present invention.

Referring to FIG. 1, a substrate treating equipment 1 includes an equipment front end module (EFEM) 10, and a processing room 20. The EFEM 10 and the processing room 20 are arranged in one direction. Hereinafter, a direction in which the EFEM 10 and the processing room 20 are arranged is defined as a first direction (X), and as viewed from the top, a direction perpendicular to the first direction (X) is defined as a second direction (Y).

The EFEM 10 is equipped in front of the processing room 20, and transfers a substrate between a carrier 16 in which the substrate is received, and the processing room 20. The EFEM 10 includes a rod port 12 and a frame 14.

The rod port 12 is disposed in front of the frame 14 and is provided in plurality. The rod ports 12 are spaced apart from each other and are arranged in a row along the second direction (Y). The carrier 16 (e.g., cassette, FOUP, etc.) is mounted on each of the rod ports 12. The carrier 16 receives therein a to-be-processed substrate (W), and a processed substrate (W).

The frame 14 is disposed between the rod port 12 and a load lock chamber 22. A transfer robot 18 transferring the substrate (W) between the rod port 12 and the load lock chamber 22 is disposed within the frame. The transfer robot 18 is movable along a transfer rail 19 disposed in the second direction (Y).

The processing room 20 includes a load lock chamber 22, a transfer chamber 24, and a plurality of substrate treating apparatuses 30.

The load lock chamber 22 is disposed between the transfer chamber 24 and the frame 14 to provide a standby space before a to-be-processed substrate (W) is transferred to the substrate treating apparatus 30, or before a processed substrate (W) is transferred to the carrier 16. The load lock chamber 22 may be provided singularly or in plurality. In an embodiment, the number of the load lock chamber 22 is two. A substrate (W) which is provided to the substrate treating apparatus 30 for a process treatment may be received in one load lock chamber 22, and a substrate (W), which is processed by the substrate treating apparatus 30 may be received in the other load lock chamber 22.

The transfer chamber 24 is disposed in the first direction (X) behind the load lock chamber 22, and as viewed from the top, the transfer chamber 24 has a polygonal body 25. The load lock chambers 22 and the plurality of substrate treating apparatuses 30 are disposed along the circumference of the body 25 outside the body 25. In an embodiment, as viewed from the top, the transfer chamber 24 may have a hexagonal body. The load lock chambers 22 are disposed on two sidewalls of the body 25 adjacent to the EFEM 10, respectively, and the substrate treating apparatuses 30 are disposed on the remaining sidewalls. A passage (not shown) through which the substrate (W) is loaded or unloaded is formed at each sidewall of the body 25. The passage provides a space through which the substrate (W) is loaded or unloaded between the transfer chamber 24 and the load lock chamber 22, or between the transfer chamber 24 and the substrate treating apparatus 30. A door (not shown) opening and closing the passage is provided to each passage. The transfer chamber 24 may be provided in various forms according to the required process module.

A transfer robot 26 is disposed inside the transfer chamber 24. The transfer robot 26 transfers a non-treated substrate (W), which is on standby in the load lock chamber 22, to the substrate treating apparatus 30, or transfers a substrate (W), which is processed by the substrate treating apparatus 30, to the load lock chamber 22. The transfer robot 26 may sequentially provide the substrates (W) to the substrate treating apparatuses 30.

The substrate treating apparatus 30 supplies a gas in a plasma state to the substrate to perform a process. The plasma gas may be variously used in a semiconductor manufacturing process. While it is hereinafter described that the substrate treating apparatus 30 performs an ashing process removing a photoresist film coated on a substrate, the present invention is not limited thereto, and may be applied to various processes using a plasma gas, such as an etching process, a deposition process, or the like.

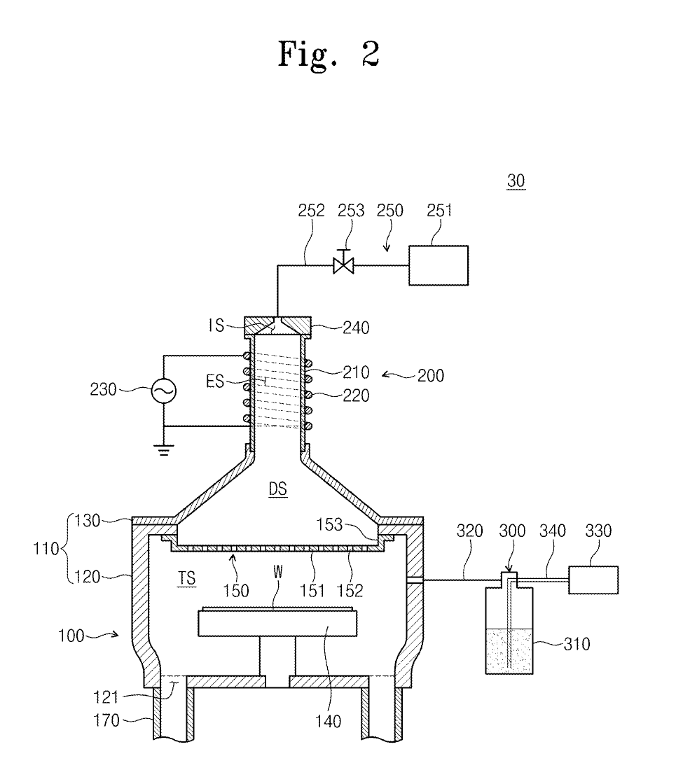

FIG. 2 is a sectional view schematically illustrating a substrate treating apparatus according to an embodiment of the present invention.

Referring to FIG. 2, the substrate treating apparatus 30 includes a processing part 100, a plasma supply part 200, and a surface treating material supply part 300.

The processing part 100 provides a space where a substrate is processed, and the plasma supply part 200 generates a plasma used in a substrate (W) treating process, and supplies the generated plasma to the substrate (W) in a downstream manner. The surface treating material supply part 300 supplies a surface treating material to an inside of the process chamber 110 to treat surfaces of devices provided to the inside of the process chamber 110. Hereinafter, the respective elements will be described in detail.

The processing part 100 has a process chamber 110, a susceptor 140, and a baffle 150.

The process chamber 110 provides a treatment space (TS) in which a substrate treatment is performed. The process chamber 110 has a body 120 and a seal cover 130. The body 120 has an opened upper surface, and a space formed therein. An opening through which the substrate (W) is loaded or unloaded is formed at a sidewall of the body 120, and is opened or closed by an opening/closing member, such as a slit door (not shown). The opening/closing member closes the opening while a substrate (W) treatment is performed in the process chamber 110, and opens the opening when the substrate (W) is loaded into the process chamber 110 and is unloaded to the outside. An exhaust hole 121 is formed at a lower sidewall of the body 120. The exhaust hole 121 is connected to an exhaust line 170. The inner pressure of the process chamber 110 is adjusted through the exhaust line 170, and a reaction byproduct generated in a process is exhausted to the outside of the process chamber 110. In an example, the process chamber 110 may have an inner side surface which is surface-treated by a surface treating material.

The seal cover 130 is coupled to an upper wall of the body 120 and covers the opened upper surface of the body 120 to seal the inside of the body 120. An upper end of the seal cover 130 is connected to the plasma supply part 200. The seal cover 130 is formed with an inducement space (DS). The inducement space (DS) may be provided in a reverse funnel shape. A plasma gas supplied from the plasma gas supply part 200 is diffused in the inducement space (DS) and moves to the baffle 150.

The susceptor 140 is positioned in the treatment space (TS) to support the substrate (W). The susceptor 140 may include an electro static chuck adsorbing the substrate (W) using an electro static force. The susceptor 140 may be formed with lift holes (not shown). Lift pins (not shown) are respectively provided in the lift holes. The lift pins are lifted along the lift holes when the substrate (W) is loaded on/unloaded from the susceptor 140. A heater (not shown) may be provided inside the susceptor 140. The heater heats the substrate (W) to maintain a process temperature.

The baffle 150 is coupled with the upper wall of the body 120 between the body 120 and the seal cover 130. The baffle 150 may be formed of a metal or a dielectric material. For example, the baffle 150 may be formed of nickel or aluminum. Alternatively, the baffle 150 may be formed of quartz or an alumina material.

The baffle 150 has a base 151 and a coupling part 153. The base 151 has a circular plate shape and is disposed in parallel to the top surface of the susceptor 140. The base 151 may have an area wider than the substrate (W). The base 151 has a bottom surface which faces the susceptor 140 and is flat. The base 151 is formed with holes 152.

The plasma diffused in the induction space (DS) passes through the holes 152 and is introduced into the treatment space (TS).

The coupling part 154 protrudes upward from an upper edge region of the base 151 and has a ring shape. The coupling part 154 is provided as a region where the baffle 150 is coupled with the upper wall of the body 120.

The baffle 150 is surface-treated with a surface treating material. The inner side surface of the process chamber 110 may be also surface-treated with a surface treating material together with the baffle 150. In the process chamber 110, the inner side surface of the body 120 may be surface-treated with a surface treating material. The surface treating material includes a silicon compound. In an example, the surface treating material may include a silane-based compound. The silicon compound may include any one of hexamethyldisiloxane (HMDSO), tetraethoxysiliane, and silane. In an example, the surface treating material may be provided as a mixture of hexamethyldisiloxane (HMDSO), tetraethoxysiliane, or silane with oxygen (O₂). By the surface treatment, the inner side surface of the process chamber 110 and the surface of the baffle 150 may be coated with silicon dioxide (SiO₂).

The surface treating material may treat the inner side surface of the process chamber 110 and the surface of the baffle 150 in a polar or a non-polar state according to the bonding degree between the surface treating material and oxygen. The inner side surface of the process chamber 110 and the surface of the baffle 150 are coated in a polar state when the surface treatment is performed in a state that the surface treating material is bonded with oxygen. Unlike this, the inner side surface of the process chamber 110 and the surface of the baffle 150 are coated in a non-polar state when the surface treatment is performed in a state that the surface treating material is not bonded with oxygen. In an example, whether or not the surface treating material bonds with oxygen may be determined by a reaction time between the surface treating material and a plasma. By increasing the reaction time between the surface treating material and the plasma, the bonding between the surface treating material and oxygen is prevented. Therefore, by decreasing the reaction time between the surface treating material and the plasma, the inner side surface of the process chamber 110 and the surface of the baffle 150 may be treated in a state that the surface treating material bonds with oxygen. Also, by increasing the reaction time between the surface treating material and the plasma, the inner side surface of the process chamber 110 and the surface of the baffle 150 may be treated in a state that the surface treating material does not bond with oxygen.

While the inside of the process chamber 110 facing the treatment space (TS) is surface-treated using a silicon compound, the inner side surface of the process chamber 110 and the surface of the baffle 150 may be coated in a polar or a non-polar state. By doing so, it may be prevented that the plasma gas reacts with aluminum in the inner side surface of the process chamber 110. Therefore, an increased amount of plasma gas may directly react with photoresist. Also, the increased amount of plasma gas may enhance the ashing rate in a substrate treating process using a plasma.

Further, it may be prevented that the inner side surface of the process chamber 110 and the surface of the baffle 150 react with active species and radicals contained in the plasma gas. Thus, fluxes of the active species and the radicals contained in the plasma gas may be maintained. This contributes to enhancement in ashing rate.

The surface treating material may treat the bottom surface of the base 151 in the baffle 150. During the process time, most of the plasma gas stays at a space between the base 151 and the susceptor 140. Since the bottom surface of the base 151 is exposed through the process time, it is required that the bottom surface of the base 151 be surface-treated, as compared with other regions of the baffle 150.

The plasma supply part 200 excites the process gas to generate a plasma gas and supplies the generated plasma gas to the substrate (W).

The plasma supply part 200 includes a reactor 210, an induction coil 220, a power source 230, a gas injection port 240, and a process gas supply part 250.

The reactor 210 is positioned above the seal cover 130, and has a bottom surface which is coupled with the top end of the seal cover 130. The reactor 210 has a top surface and a bottom surface which are opened, and a space (ES) therein. The inner surface (ES) of the reactor 210 is provided as a discharge space where a plasma is generated. The top end of the reactor 210 is connected to the gas injection port 240, and the bottom end of the reactor 210 is connected to the seal cover 130.

The induction coil 220 is wound on the reactor 210. The induction coil 220 is wound several times along a circumference of the reactor 210. One end of the induction coil 220 is connected to the power source 230 and the other end is grounded. The power source 230 applies a radio frequency (RF) power or a microwave power to the induction coil 220.

The gas injection port 240 is coupled to the top end of the reactor 210 and supplies a process gas to the discharge space (ES). An induction space (IS) is formed under the gas injection port 240. The induction space (IS) has a reverse funnel shape and is connected to the discharge space (ES). The process gas introduced into the induction space (IS) is diffused and moves to the discharge space (ES).

The process gas supply part 250 supplies the process gas to the discharge space (ES). The process gas supply part 250 includes a process gas storage part 251, a process gas supply line 252, and a valve 253.

The process gas storage part 251 stores the process gas. The process gas may be provided in the form of a gas including at least one of oxygen (O₂), hydrogen (H₂), ammonia (NH₃), argon (Ar), and helium (He). The process gas supply line 252 connects the process gas storage part 251 and the gas injection port 240.

The process gas is supplied to the discharge space (ES) through the process gas supply line 252. The valve 253 is installed on the process gas supply line 252. The valve 253 adjusts the flow rate of the process gas supplied through the process gas supply line 252.

The surface treating material supply part 300 supplies a surface treating material to the treatment space (TS). The surface treating material supply part 300 includes a container 300, a surface treating material supply line 320, an inert gas storage part 330, and an inert gas supply line 340. In an example, the surface treating material may be supplied to the treatment space (TS) in a gas state.

The container 310 contains therein the surface treating material. The surface treating material supply line 320 connects the process chamber 110 and the container 310. The surface treating material supply line 320 is connected to the process chamber at a height between the baffle 150 and the susceptor 140.

The inert gas supply line 340 connects the inert gas storage part 330 and the container 310. One end of the inert gas supply line 340 is dipped in the surface treating material contained in the container 310. An inert gas stored in the inert gas storage part 330 is injected into the container 310 through the inert gas supply line 340. The injection of the inert gas allows the inner pressure of the container 310 to increase, and the surface treating material is supplied to the inside of the process chamber 110 through the surface treating material supply line 320 in a gas state together with the inert gas. The inert gas may be provided in the form of a gas including at least one of argon (Ar), nitrogen (N2), and helium (He).

While it has been described that the above-described substrate treating apparatus treats the surfaces of the baffle and the substrate treating apparatus by supplying the surface treating material in a gas state, it is also possible to treat the surfaces of the baffle and the substrate treating apparatus by supplying the surface treating material in a liquid state.

Hereinafter, a method of treating the inner side surface of the process chamber and the surface of the baffle using the above-described substrate treating apparatus will be described.

Right after the setting of the substrate treating apparatus or in the case of putting a pause between processes, the inner atmosphere of the process chamber 110 is not stabilized. If a substrate treating process is performed in such a state, the substrate may be wasted, and thus the surface treating process is performed before an actual substrate treating process is performed.

The surface treating process is performed as follows. First, a process gas is supplied from the process gas supply part 250 to the discharge space (ES). An electric power is applied from the power source 230 to the induction coil 220 to form an induced electric field in the discharge space (ES). The process gas obtains energy necessary for ionization from the induced electric field and is excited to a plasma state.

The plasma gas moves from the discharge space (ES) to the induction space (DS), passes through the holes 152 of the baffle 150, and is then introduced into the space between the baffle 150 and the susceptor 140.

While the plasma gas is introduced into the space between the baffle 150 and the susceptor 140, the surface treating material supply part 300 supplies a mixture gas of the surface treating material and the inert gas to the inside of the process chamber 110. In an example, the surface treating material is provided to the treatment space (TS) in a gas state. The surface treating material obtains energy from the excited process gas and is then excited to a plasma state to surface-treat the inner side surfaces of the baffle 150 and the process chamber 110. It is determined whether or not a bonding between the surface treating material and oxygen is maintained according to the reaction time between the surface treating material and the process gas which is excited to the plasma state. The bonding between the surface treating material and oxygen is broken when the reaction time between the surface treating material and the process gas which is excited to the plasma state becomes long. Unlike this, when the reaction time between the surface treating material and the process gas which is excited to the plasma state is short, the surface treating material surface-treats the inner side surfaces of the baffle 150 and the process chamber 110 in a state that the bonding between the surface treating material and oxygen is maintained. When the surface treating material surface-treats the inner side surfaces of the baffle 150 and the process chamber 110 in a state that the bonding between the surface treating material and oxygen is maintained, the inner side surfaces of the baffle 150 and the process chamber 110 are coated to a polar state. Unlike this, when the surface treating material surface-treats the inner side surfaces of the baffle 150 and the process chamber 110 in a state that the bonding between the surface treating material and oxygen is broken, the inner side surfaces of the baffle 150 and the process chamber 110 are coated to a non-polar state. The surface treating material may be supplied in a flow rate of 1 cc/min to 10 l/min. The above-described flow rate of the surface treating material enables to sufficiently surface-treat the entire region of the bottom surface of the baffle 150 and the entire region of the inner side surface of the process chamber 110. If the flow rate of the surface treating material is less than the above-described range, a plasma is not sufficiently generated and thus it is difficult to achieve desired surface treating effects. Unlike this, if the flow rate of the surface treating material exceeds the upper limit of the above-described range, the activation of the plasma gas is lowered and thus it is difficult to achieve desired surface treating effects.

When the surface treating process is completed, the supply of the surface treating material stops. A gas staying in the process chamber 110 is exhausted to the outside through the exhaust line 170. After the surface treating process, a substrate (W) to be provided in an actual process is loaded into the chamber 110 and is placed on the susceptor 140. A process gas is again supplied to the discharge space (ES) and after being discharged to a plasma state in the discharge space (ES), is provided to the substrate (W). The plasma gas removes a photoresist film coated on the substrate (W).

While the process is performed, the plasma gas contacts the surface of the baffle 150 and the inner side surfaces of the process chamber 110. Since the silicon compound used for the surface treatment does not react active species and radicals, the flow rates of the active species and the radicals are maintained constantly. Due to this, since a large amount of active species and radicals is supplied to the substrate, the ashing rate is enhanced.

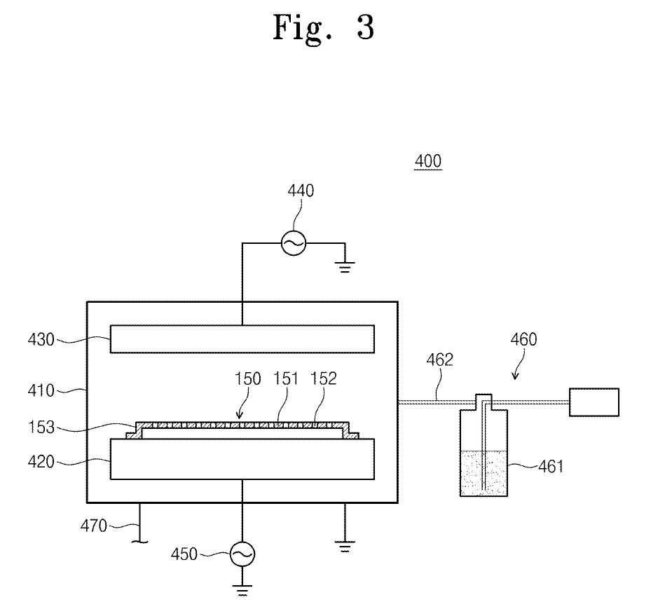

FIG. 3 is a sectional view illustrating a substrate treating apparatus according to an embodiment of the present invention.

Referring to FIG. 3, a surface treating apparatus 400 performs a surface treatment for various devices installed on inner side surfaces of the above-described chamber and in the inside of the chamber. The present embodiment will be described with an example in which the surface treating apparatus 400 performs a surface treatment of a baffle 150. The surface treating apparatus 400 includes a surface treating chamber 410, an upper electrode 430, an upper power source 440, a lower power source 450, a surface treating material supply part 460, and an exhaust member 470.

The surface treating chamber 410 provides a space where the surface treatment of the baffle 150 is performed. The surface treating chamber 410 is provided therein with a support plate 420. The support plate 420 has a circular plate shape, and a radius which corresponds to or is larger than the baffle 150.

The baffle 150 is placed on the support plate 420. The baffle 150 is placed on the support plate 420 such that a coupling part 153 contacts a top surface of the support plate 420, and a bottom surface of a base 152 faces the top surface of the support plate 420. The support plate 420 is provided as the lower electrode and is electrically connected to the lower power source 450.

The upper electrode 430 is positioned above the support plate 420 and faces the support plate 420. The upper electrode 430 is electrically connected to the upper power source 440. When power is applied to the upper electrode 430 from the upper power source 440, an electric field is formed in a space between the upper electrode 430 and the support plate 420.

The exhaust member 470 is connected to the surface treating chamber 410. The exhaust member 470 adjusts the inner pressure of the surface treating chamber 410 and exhausts a gas staying in the surface treating chamber 410 to the outside.

The surface treating material supply part 460 supplies a surface treating material to an inner space of the surface treating chamber 410. The surface treating material supply part 460 includes a container 461, a surface treating material supply line 462, an inert gas storage part 463, and an inert gas supply line 464.

The container 461 contains therein the surface treating material. The surface treating material supply line 462 connects the surface treating chamber 410 and the container 461. The surface treating material supply line 462 is connected to the surface treating chamber 410 at a region between the baffle 150 and the support plate 420.

The inert gas supply line 464 connects the inert gas storage part 463 and the container 461. An inert gas stored in the inert gas storage part 463 is supplied into the container 461 through the inert gas supply line 464. The supply of the inert gas allows the inner pressure of the container 461 to increase, and the surface treating material is supplied to the inside of the process chamber 410 through the surface treating material supply line 462 in a gas state together with the inert gas. The surface treating material and the inert gas are supplied to a space between the support plate 420 and the upper electrode 430.

When an electric field is formed between the space between the upper electrode 430 and the support plate 420 by applying power to the upper electrode 430, the surface treating material is excited to a plasma state. The excited surface treating material is supplied to the baffle 150 to treat the surface of the baffle 150. At this time, the inert gas stabilizes the state of the excited surface treating material such that the surface treatment of the baffle 150 is uniformly performed. In the above-described example, the lower power source 450 may be not provided.

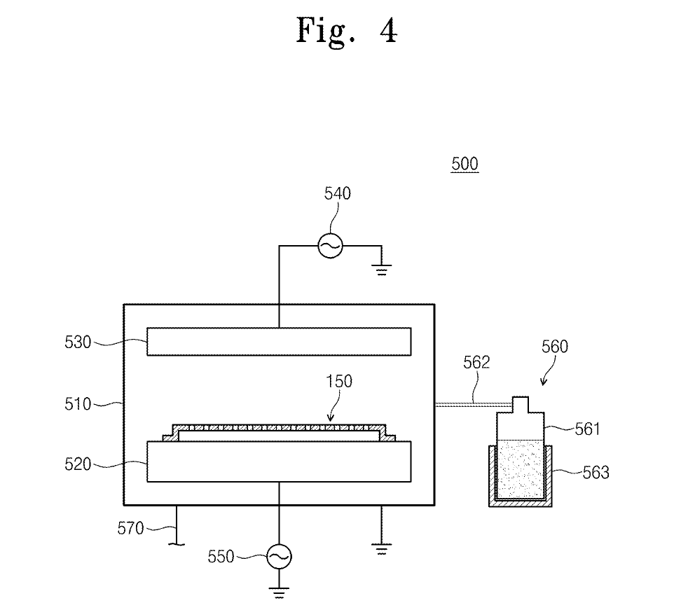

FIG. 4 is a sectional view illustrating a substrate treating apparatus according to another embodiment of the present invention.

Referring to FIG. 4, unlike the surface treating material supply part 460 illustrated in FIG. 3, a surface treating material supply part 560 heats a surface treating material contained in a container 561 to generate a surface treating material.

A heater 563 is provided so as to enclose the container 561. When heat is generated from the heater 563, a surface treating material is generated in the container 561. The generated surface treating material is supplied to a surface treating chamber 510 through a surface treating material supply line 562.

The surface treating material supply part 560 may be also applied to the surface treating material supply part 300 of the above-described surface treating apparatus (30 of FIG. 2).

The surface treating apparatuses which treat the surface of the baffle using plasma have been described in the above. Unlike the above description, a surface treatment may be performed after a surface treating material is coated in a liquid state on the baffle. Hereinafter, a surface treating apparatus treating the surface of the baffle using a surface treating material in a liquid state will be described.

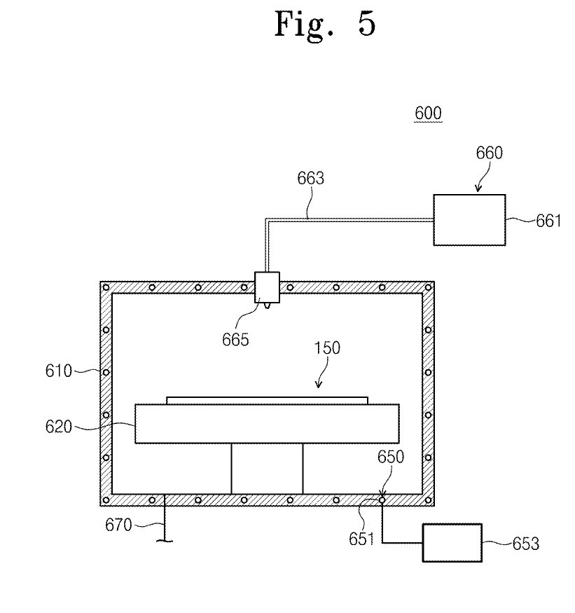

FIG. 5 is a sectional view illustrating a substrate treating apparatus according to still another embodiment of the present invention.

Referring to FIG. 5, unlike the surface treating apparatus 400 illustrated in FIG. 3, a surface treating material in a liquid state is directly coated on a surface of a baffle 150. Through the direct coating, the surface treating material reacts with the surface of the baffle 150 to treat the surface of the baffle 150. Similarly to this, the inner side surface of the surface treating chamber 410 may be surface-treated with a surface treating material in a liquid state. In an example, unlike the surface treating apparatus 400 illustrated in FIG. 3, the upper electrode, the lower electrode, the upper power source and the lower power source may not be provided.

A surface treating apparatus 600 includes a surface treating chamber 610, a support plate 620, a temperature control member 650, a surface treating material supply member 660, and an exhaust member 670.

Unlike the surface treating apparatus 300 illustrated in FIG. 3, the surface treating apparatus 600 treats the surface of the baffle 150 using a surface treating material in a liquid state. In an example, the surface treating material supply member 660 may coat a surface treating material in a liquid state from a point above the baffle 150 toward the baffle 150.

Although not illustrated, the support plate 620 may be connected to a driving part (not shown). The driving part (not shown) may deliver a rotational force to the support plate 620. The support plate 620 may rotate while the surface treating material is coated on the baffle 150. Selectively, the driving part (not shown) may not be provided.

The surface treating material supply member 660 may include a surface treating material storage part 661, a surface treating material supply line 663, and a spray nozzle 665. The surface treating material storage part 661 stores the surface treating material. The surface treating material supply line 663 connects the surface treating material storage part 661 and the spray nozzle 665. The surface treating material moves through the surface treating material supply line 663. The spray nozzle 665 may be provided above the surface treating chamber 610. The spray nozzle 665 may be provided above the surface treating chamber 620. The spray nozzle 665 sprays the surface treating material in a liquid state toward the baffle 150. Although not illustrated, the surface treating material supply member 660 may further include a spray nozzle transfer member which is disposed in the surface treating chamber 610 to transfer the spray nozzle 665.

Unlike the surface treating apparatus 300 illustrated in FIG. 3, the surface treating apparatus 600 includes the temperature control member 650. The temperature control member 650 may include a heater 651 and a power source 653. The temperature control member 650 controls the inner temperature of the chamber 610. The temperature control member 650 may control the inner temperature of the chamber 610 such that the surface treating material in a liquid state reacts with the inner side surface of the chamber 610 and the surface of the baffle 150. In an example, the temperature control member 650 may be provided inside the chamber 610.

Although not illustrated, the surface treating apparatus may include a container containing the surface treating material in a liquid state. The container may have a diameter larger than the baffle such that the baffle is submerged in the surface treating material contained in the container. In an example, the baffle may be provided so as to be submerged in the surface treating material in a liquid state contained in the container. Thus, the baffle may be surface-treated.

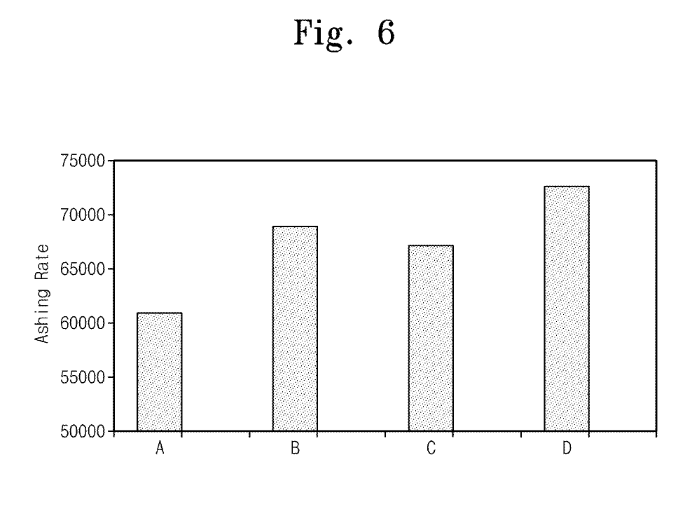

FIG. 6 is a graph showing the ashing rates of process chambers having different surface states.

Referring to FIG. 6, a first result value (A) corresponds to a case in which an ashing process is performed using an inner side surface of a chamber and a baffle which are not surface-treated. In this case (A), the ashing rate is about 61,000 Å/mm.

A second result value (B) corresponds to a case in which an ashing process is performed using an inner side surface of a chamber and a baffle which are surface-treated. In this case (A), the ashing rate is about 68,000 Å/mm.

A third result value (C) corresponds to a case in which an ashing process is performed using an inner side surface of a chamber and a baffle which are surface-treated with an aromatic compound. The aromatic compound used in this experiment is toluene. In this case (C), the ashing rate is about 67,000 Å/mm.

A fourth result value (D) corresponds to a case in which an ashing process is performed using an inner side surface of a chamber and a baffle which are surface-treated with a silicon compound. The silicon compound used in this experiment is a mixture of hexamethyldisiloxane (HMDSO) and oxygen (O₂). In this case (C), the ashing rate is about 73,000 Å/mm.

From the graph of FIG. 6, it may be seen that when the ashing process is performed using the inner side surface of the chamber and the baffle which are surface-treated with the silicon compound, the ashing rate is highest. This means that the amounts of active species and radicals in the case where the surface is treated with the silicon compound are relatively larger than those in the case where the surface is not treated.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A baffle which is formed with holes designed for distributing a process gas excited to a plasma state, the baffle having a surface which is treated with a surface treating material comprising a silicon compound.

2. The baffle of claim 1, wherein the baffle comprises:
a base formed with the holes; and
a coupling part protruding upward from an upper edge region of the base and having a ring shape,
wherein the surface treating material treats a bottom surface of the base.

3. The baffle of claim 1, wherein the surface of the baffle which is treated has a polar state.

4. The baffle of claim 1, wherein the surface of the baffle which is treated has a non-polar state.

5. The baffle of claim 1, wherein the silicon compound comprises a silane-based compound.

6. The baffle of claim 5, wherein the silicon compound comprises hexamethyldisiloxane (HMDSO).

7. The baffle of claim 1, wherein the surface-treated baffle has a surface which is coated with silicon dioxide (SiO₂).

8. A substrate treating apparatus comprising:
a process chamber having a space formed therein;
a susceptor positioned inside the process chamber to support a substrate; and
a process gas supply part supplying a process gas in a plasma state to the inside of the process chamber,
wherein an inner side surface of the process chamber is treated with a surface treating material comprising a silicon compound.

9. The substrate treating apparatus of claim 8, wherein the inner side surface of the process chamber which is treated has a polar state.

10. The substrate treating apparatus of claim 8, wherein the inner side surface of the process chamber which is treated has a non-polar state.

11. The substrate treating apparatus of claim 8, wherein the inner side surface of the process chamber which is treated is coated with silicon dioxide (SiO₂).

12. The substrate treating apparatus of claim 8, further comprising a baffle positioned above the susceptor and formed with holes distributing the process gas provided to the substrate,
wherein the baffle has a surface which is treated with a surface treating material.

13. The substrate treating apparatus of claim 12, wherein the surface of the baffle which is treated is a bottom surface facing the substrate.

14. The substrate treating apparatus of claim 13, wherein the bottom surface of the baffle which is treated has a polar state.

15. The substrate treating apparatus of claim 13, wherein the bottom surface of the baffle which is treated has a non-polar state.

16. The substrate treating apparatus of claim 13, wherein the bottom surface of the baffle which is treated is coated with silicon dioxide (SiO₂).

17. A baffle surface treating apparatus comprising:
a surface treating chamber having a space formed therein;
a support plate which is positioned inside the surface treating chamber and provided as a lower electrode, and on which a baffle is placed;
an upper electrode which is disposed above the support plate to face the support plate and forms an electric field in a space between the support plate and the upper electrode; and
a surface treating gas supply unit supplying a surface treating gas including a silicon compound to a space between the support plate and the upper electrode,
wherein the surface treating gas is excited to a plasma state by the electric field and treats a surface of the baffle

18. The baffle surface treating apparatus of claim 17, wherein the baffle comprises:
a base formed with holes; and
a coupling part protruding upward from an upper edge region of the base and having a ring shape,
wherein the baffle is placed on the support plate such that the bottom surface of the base faces the upper electrode.

19. The baffle surface treating apparatus of claim 17, wherein the surface treating gas supply part comprises:
a container storing the surface treating material including the silicon compound;
an inert gas supply part injecting an inert gas to the container to pressurize the inside of the container; and
a gas supply line connecting the surface treating chamber and the container and supplying the surface treating gas generated in the inside of the container to the inside of the surface treating chamber.

20. The baffle surface treating apparatus of claim 17, wherein the surface treating gas supply part comprises:
a container storing a surface treating material including the silicon compound;
a heater heating the inside of the container; and
a gas supply line connecting the surface treating chamber and the container and supplying the surface treating gas generated in the inside of the container to the inside of the surface treating chamber.

21. The baffle surface treating apparatus of claim 13, wherein the silicon compound comprises a silane-based compound.
